(19) United States
(12) Patent Application Publication
(10) Pub. No.: US 2011/0123903 A1
(43) Pub. Date: May 26, 2011

(54) FUEL CELL ARRANGEMENT

(75) Inventors: Anton Trenkler, Ebersberg (DE); Wolfgang Wagner, Neubiberg (DE)

(73) Assignee: MTU Onsite Energy GmbH

(21) Appl. No.: 12/954,069

(22) Filed: Nov. 24, 2010

(30) Foreign Application Priority Data
Nov. 25, 2009 (DE) DE 102009055662.1

(51) Int. Cl. H01M 2/08

(52) U.S. Cl. 429/508

(57) ABSTRACT

A fuel cell arrangement (1) with an end plate (4), a fuel cell (2) adjoining in a longitudinal direction, as well as a longitudinal seal (9) and a transverse seal (10), where the transverse seal (10) extends in a transverse direction along the end plate (4) and where the longitudinal seal (9) extends along the fuel cell (2) and the end plate (4) in a longitudinal direction as far as the transverse seal (10), where for sealing an open crack in the area between the end plate (4), the fuel cell (2), the transverse seal (9) and the longitudinal seal in transverse direction, a sealing cheek (12) is pressed via a flexible pressing element (18) against a vertically supported projection (13), as well as the end plate (4) and the fuel cell (2), where the sealing cheek (12) forms a in the direction of the fuel cell (2) and of the end plate (4) a sliding surface (16, 24, 26, 28, 29) and where the sealing cheek (12) has a contact section (15) corresponding with a contact section (14) of the projection (13).

### CROSS-REFERENCE TO RELATED APPLICATIONS

This application claims priority based on German Patent Application 10 2009 055 662.1 filed Nov. 25, 2009, which is hereby incorporated by reference in its entirety.

### TECHNICAL FIELD

The present invention concerns a fuel cell arrangement according to the generic terms of Claim 1.

### BACKGROUND

Fuel cell arrangements of the present type are known in the state-of-technology, for example in document WO 2008/110291 A1. They normally comprise a stack of several fuel cells, as well as, for example, a manifold or gas distributor on each side for the entry and exit of streams of gas. Between the stack of fuel cells and the manifold is normally arranged a sealing device, which may have the form of sealing frame containing the sealing elements, for example longitudinal sealing elements along the longitudinal edge of the manifold and transversal sealing elements. The sealing elements typically consist of non-electrically conducting material, where, for example, the sealing arrangement transmits the entire mass of the cell stack to the manifold.

During operation, the end-plates of the cell stack arranged on the front of the cell stack, move in longitudinal direction, as do the seals in relation to one another and for example in relation to the manifold. These movements are for example triggered by a rise of temperature from ambient to operating level, i.e. ˜650° C. via different material combinations, or chemical processes. The said movements can likewise occur after operation over an extended period, due to the deceasing or changing dimensions of the cell stack. At the end-plates, movements in the longitudinal, vertical or transverse direction of the cell stack axis, as well as rotational, or composite movements, may ensue.

As a result of such movements, a lack of sealing capacity may develop in the form of a crack of variable cross-section such as a polygon, in the area of a frame corner in transverse direction i.e. in the area of the fuel cell, the end plate or of the transverse and longitudinal seals. Such a crack makes possible an undesirable mixing of anode and cathode gases potentially leading to a dangerous operating mode, as well as to damage of the fuel cell stack. Known seals are unable, or only inadequately able to seal such a crack.

### SUMMARY

Based on the foregoing, the present invention has the task of providing a fuel cell arrangement able to overcome the aforementioned drawbacks and to make possible a reliable seal of a crack which has formed transversely in the area of the end plate, of the fuel cell and of the transverse and longitudinal seal.

According to the invention, the aforementioned task is solved by the characteristics of Claim 1.

The invention provides a fuel cell arrangement with an end plate, with a neighboring fuel cell and a longitudinal seal and a transverse seal, where the transverse seal extends transversely along the end-plate and where the longitudinal seal extends along the fuel cell and the end plate in longitudinal direction as far as the transverse seal, where for the purpose of sealing an open crack in the area between the end plate, the fuel cell. the transverse seal and the longitudinal seal, a sealing cheek is pressed by means of an elastic pressing element against a protrusion formed in transverse direction by the longitudinal and transverse seals, as well as against the end plate and the fuel cell where the sealing cheek forms a sliding surface in the direction of the fuel cell and the end plate and where the sealing cheek has a contact section corresponding to the contact section of the protrusion.

In an embodiment of the invention the contact section of the protrusion is formed by the transverse seal, in order to prevent relative movement of the sealing cheek pressed against the contact section in longitudinal direction.

In a further embodiment of the fuel cell arrangement according to the invention, the sealing cheek has a guide and/or an uptake for the pressing element.

In a yet further embodiment of the fuel cell arrangement, the pressure cheek has two elements such that a contact element of the sealing cheek is formed for contact with the fuel cell and the end plate, as well as a first sliding surface for contact with a pressure element, where the pressure element is pressed against the contact element via the pressing element, where the pressure element acts jointly with the contact element against the relative vertical movement and where the pressure element has a second sliding surface for contact with the first sliding surface, where the contact element is pressed via the pressure element and via the sliding surfaces in a longitudinal sliding manner against the projection, the end plate and the fuel cell.

In accordance with an aspect of the fuel cell arrangement according to the invention, the projection has a first contact section for contact with the contact element and a second contact section for contact with the pressure element, where the contact element and the pressure element has each a section corresponding to the first or the second contact section, where the first contact section is formed for sliding contact in longitudinal direction and where the second contact section has a contact section formed by the transverse seal for preventing a relative movement of the pressure element in longitudinal direction.

Likewise provided is a fuel cell arrangement where the sealing cheek has a third adapter element such that the said adapter element is pressed against the pressure element via the pressing element, where the adapter element acts jointly with the pressure element against vertical relative movement, where the pressure element has a third sliding surface and where the adapter element has a fourth sliding surface, where the adapter element can be slid by means of the third and fourth sliding surfaces relatively to the pressure element, where the contact element is pressed via the pressure element and the adapter element against the projection, the end plate and the fuel cell to one another via the sliding surfaces in longitudinal sliding direction.

In accordance with an aspect of the fuel cell arrangement according to the invention, the projection has a third contact section for contact with the adapter element, where the adapter element has a third section corresponding with the third contact section, where the third contact section is formed for sliding contact of the adapter element in longitudinal direction, in particular away from the transverse seal.

In an embodiment of the fuel cell arrangement according to the invention, the contact element and the pressure element and/or the pressure element and the adapter element have corresponding sections for the prevention of vertical relative movement.

In a further embodiment of the fuel cell arrangement according to the invention, the contact section is formed by the longitudinal seal of the projection for sliding contact in longitudinal direction.

In a still further embodiment of the fuel cell arrangement according to the invention, the pressing element is a spring, in particular a spring with an S-shaped cross-section, where the pressing element exerts a force on the sealing cheek in both vertical and transverse direction, in particular in the area of an expected crack.

In accordance with the invention there is likewise provided a fuel cell arrangement, where the pressing element is supported on a gas distributor of the fuel cell arrangement, in particular by means of a retainer.

In an embodiment of the invention of the fuel cell arrangement, the sealing cheek has an element made of dielectric material, in particular a ceramic material.

Further characteristics and advantages of the invention emerge from the description of embodiment examples, illustrated by the figures which follow and which show individual details of the invention, as well as from the Claims. Individual characteristics may be implemented singly or in combination in variants of the invention.

### BRIEF DESCRIPTION OF THE DRAWINGS

Preferred embodiments of the invention are explained more fully below with the help of the appended drawings, where

FIG. 1 shows a fuel cell arrangement according to a possible embodiment of the invention;

FIG. 2 shows a crack in transverse direction to be sealed, present in a fuel cell arrangement according to a possible embodiment of the invention;

FIG. 3 shows a fuel cell arrangement with a one-piece sealing cheek according to a possible embodiment of the invention;

FIG. 4 shows a front view of the fuel cell arrangement from FIG. 3;

FIG. 5 shows a fuel cell arrangement with a two-piece sealing cheek according to a possible embodiment of the invention;

FIG. 6 shows a front view of the fuel cell arrangement from FIG. 5;

FIG. 7 shows a fuel cell arrangement with a three-piece sealing cheek according to a possible embodiment of the invention;

FIG. 8 shows a front view of the fuel cell arrangement from FIG. 7.

In the description which follows and in the drawings, elements with the same or a similar function have the same reference signs.

### DETAILED DESCRIPTION

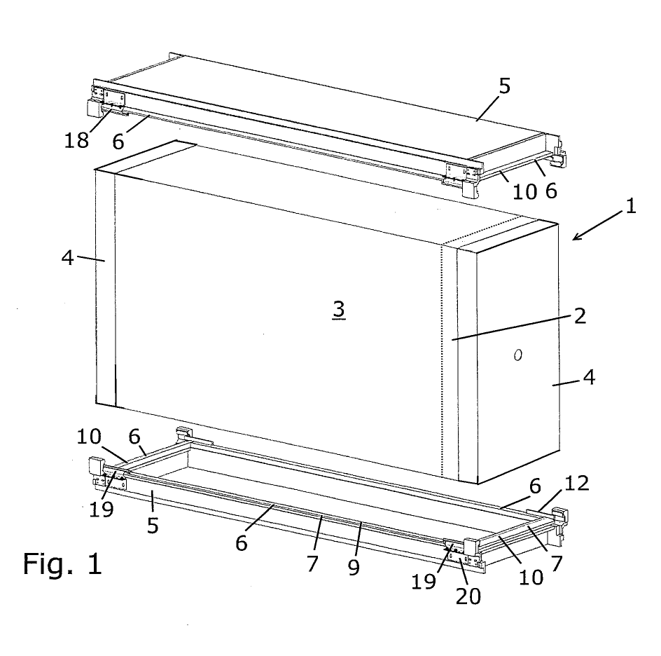

FIG. 1 shows a fuel cell arrangement 1 according to the invention. The fuel cell arrangement 1 has, for example, one or more fuel cells 2, where several fuel cells 2, are for example linked in a known manner to a fuel cell stack 3, for example by being wound. On the front of the fuel cell 2, or of a stack 3, is an end plate adjoining in longitudinal direction a fuel cell 2, where a gas distributor (manifold) 5, which extends from an end plate 4 to an end plate 4 located opposite, in order to bring or remove gas currents, namely combustion gas, oxidation gas or exhaust gas.

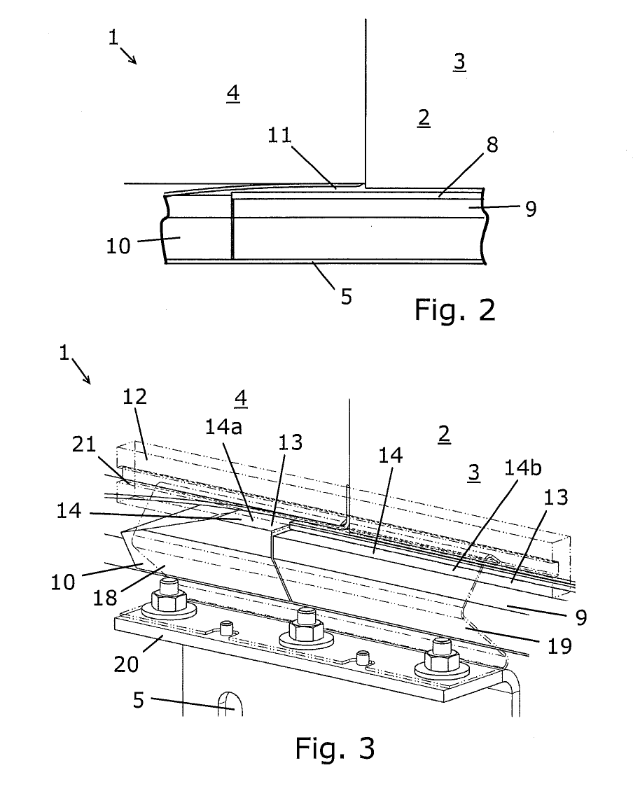

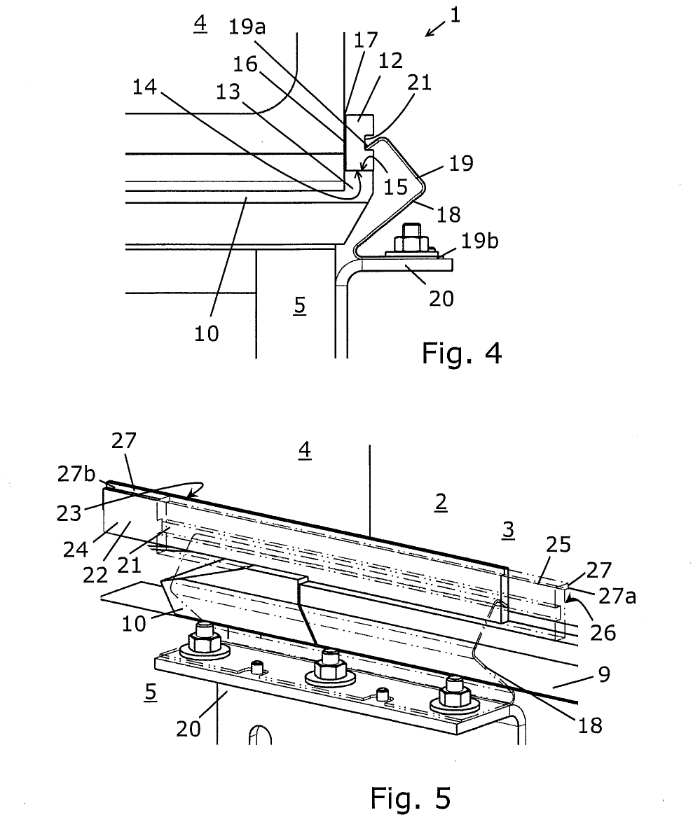

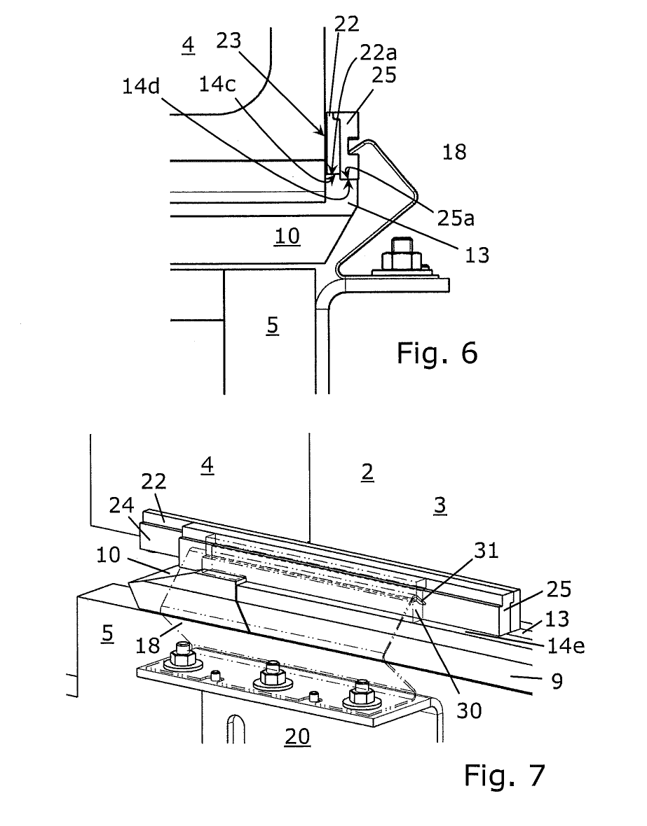

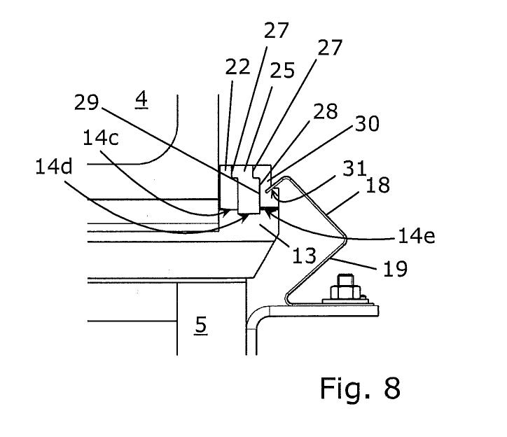

A sealing arrangement 6 is located on the gas distributor 5, which provides an electrically non-conducting seal between the gas distributor 5, the fuel cell stack 3 and the end plate 4. The sealing arrangement 6 also has, for example, ceramic sealing elements 7 (dielectrics) and/or further sealing elements 8 (FIG. 2) (e.g. sealing felt), which keep the fuel cell stack 3 (which in operation furnishes a DC voltage at a distance from the gas distributor 5 and which make possible in a known manner via longitudinal and transverse sealing elements, a seal in the form of a frame (a sealing frame).

A longitudinal sealing element, or a longitudinal seal 9, extends in longitudinal direction from an end plate 4 to an end plate 4 located opposite, along the fuel cell(s) and adjoins the end plate 4 and the fuel cells 2 as far as a transverse seal 10, which extends in transverse direction along an end plate 4, for example over its entire width. The longitudinal seal 9 overlaps in vertical direction both the fuel cell(s) 2 and partially the end plate(s) 4 in the area, where consequently the end plate 4, the fuel cell 2, the transverse seal 10 and the longitudinal seal 9 (as sealing partner) meet one another, or are arranged (for example in a frame corner of the sealing frame), that is to say, a crack 11 open in transverse direction and possessing different geometries and dimensions, may form during the movement of the sealing arrangement 6 and/or the end plate 4, or the adjoining fuel cell 2 (crack rectangle).

For sealing the different possible crack cross-sections from the outside in transverse direction, a sealing element or a sealing cheek 12 is brought into contact on the cross-section in such a way that the crack 11 is covered in transverse direction by the sealing cheek 12 and is thereby closed.

According to the invention, a contact is provided of the sealing cheek 12 or a support in both the vertical and the transverse direction, where the sealing cheek 12 is supported on the sealing arrangement 6, or on the longitudinal seal 9 and on the transverse seal 10, as well as on the fuel cell 2 and on the end plate 4, possibly using means of sealing able to be arranged in between, possibly sealing felt. The end plate 4 and the adjoining fuel cell 2 are preferably arranged in an aligned manner.

In order to make possible contact in vertical direction of the sealing cheek 12 as far as the gas distributor 5, both the longitudinal seal 9 and the transverse seal 10 have an extension in transverse direction larger than that of the end plate 4, or of the fuel cell 2, so that together they form a projection 13 outside the arrangement of the fuel cell 2 and the end plate 4 for contact of the sealing cheek 12. The jointly formed projection 13 extends in longitudinal direction, for example at least over the dimensions of the expected crack cross-section.

For support in vertical direction, the projection 13 has a contact section 14 on which the sealing cheek 12 is supported, or with which it makes contact. The contact section 14 has a first contact section 14a formed by the transverse seal 10, as well as a second contact section 14b formed by the longitudinal seal 9. The contact section 14a formed by the transverse seal 10 and the contact section 14b formed by the longitudinal seal 9, have, for example, different contours. For example, the contact section 14a of the projection 13 has a contour or a section for the prevention of relative movement of a sealing cheek 12 in longitudinal direction. The contact section 14b may for example be a sliding surface.

The sealing cheek 12 according to the invention is formed so that it can be made to contact with. or be pressed against, the projection 13, or also with the end plate 4 and the fuel cell 2 and to be sealed in conjunction with them. The sealing cheek 12 is formed so as to have, for example, a rectangular cross-section, for example substantially a parallelepiped. For contact with the projection 13 the sealing cheek 12 has for example a contact section 15 or a contour, which matches the contour of the contact section 14 of the projection 13 (contour adaptation). To this extent, the sealing cheek 12 and the projection have corresponding contact sections 14,15.

The invention provides for the sealing cheek 12 on the transverse seal 10 to be secured against relative movement to the transverse seal 10 in longitudinal direction, or brought into contact, for example via contour or form adaptation. A projection of the contact section 14a formed on the transverse seal 10, engages, for example, in a groove of the contact section 15 of the sealing cheek 12 in vertical direction, whereby, for example, the sealing cheek 12 remains in position on the corner of the sealing frame. For contact on the contact section 14b formed by the longitudinal seal 9, the contact section 15 of the sealing cheek 12 has, for example, a sliding surface.

For contact with the end plate 4 and the fuel cell 2, the sealing cheek 12 forms a sliding surface 16 (in transverse direction) of a size, making possible the sealing of a crack 11 cross-section of maximum size able to be expected. Between the sliding surface 16 and the end plate 4 or the fuel cell 2, it is, for example, possible to arrange a sealing material 17, for example a sealing felt, which for example evens out manufacturing irregularities, so that the sliding surface 16 is able to move relatively to sealing material 17 as a result of a movement of the fuel cell 2 or of the end plate 4.

The sealing cheek 12 is pressed against the projection 13, as well as against the end plate 4 and the fuel cell 2 via a pressing element 18, for example a sprung pressing element 18, in particular in the area in which a changing crack cross-section or a crack 11 can be expected. The length of the pressing element 18 corresponds, for example, to at least the length of the cross-section of crack 11 able to be expected. The flexible pressing element 18, which in the present case is a spring, may be an S-shaped spring 19, with an S-shaped cross-section. The pressing element 18 is, for example held in place by a retainer arrangement 20, for example in the form of a corner element, fastened, for example, on the gas distributor 5. The retainer arrangement 20 fastens, for example, a lower end of the spring 19. For the potential separation between fuel cell 2 and gas distributor 5, the sealing cheek 12 is, for example, made from a ceramic or a dielectric material.

The sealing cheek 12 provided with pressure power by the pressing element 18, for example a free upper end 19a of the S-shaped spring 19 in transverse direction to the end plate 4 and the fuel cell 2, as well as with a vertical pressure power towards the projection 13, or its contact section 14. The pressing element 18 is, for example, engaged with its end 19a pointing to the sealing cheek, 12 in a guide 21 or in a groove of the sealing cheek 12, into which the pressure power can be introduced.

In the case of a movement to be compensated (for example of the end plate 4 or the fuel cell 2) in transverse direction and/or combined movements with, for example, a traverse direction component, the sealing cheek 12 remains pressed against the end plate 4 and the fuel cell 2, to the extent that the pressing element 18 elastically follows the movement. In the case of a vertical movement of the fuel cell 2, or the end plate 4 away from the sealing arrangement 6, the pressing element 18 presses the sealing cheek 12 against the contact section 14 of the projection 13 and so prevents the formation of a crack 11 open outwards. The sealing cheek 12 moves in longitudinal direction together with the transverse seal 10, so that the sealing cheek 12 always remains in the area of an expected crack 11. In addition the end plate 4 and the fuel cell 2 move relatively to the sealing cheek 12 along the sliding surface 16.

The invention also provides for the sealing cheek 12 to be formed in two pieces, that is to say, with a first and a second element (FIG. 5, 6). The first element is formed as a contact element 22, provided for contact with the fuel cell 2, as well as with the end plate 4. For that purpose the contact element 22 forms in the direction of the fuel cell 2, or of the end plate 4, a contact surface 23, which may, for example be a sliding surface 16. The contact element 22 also forms a first sliding surface 24 (on the side of the pressing element) for contact with a second element of the sealing cheek 12, namely, pressure element 25. Pressure element 25 is pressed via pressing element 18 against the contact element 22, or against its first sliding surface 24 and forms a jointly acting sliding surface or second sliding surface 26, so that relative movement in longitudinal direction is possible. Pressure element 25 is thereby provided with pressure capacity in vertical and transverse direction, so that the contact element 22 is pressed via pressure element 25 against the projection 13, the end plate 4 and the fuel cell 2.

In the case of a two-piece sealing cheek 12, the projection 13 has a first contact section 14c for contact with contact element 22 and a second contact section 14d for contact with pressure element 25, where the contact element 22 has a contact section 22a which corresponds to contact section 14c and where the pressure element 25 has a contact section 25a which corresponds with contact section 14d. The first contact section 14c of the projection 13 is formed for sliding contact with contact element 22 in longitudinal direction, so that the contact element 22 can move in longitudinal direction together with the end plate 4 and the fuel cell 2. The second contact section 14d of the projection 13 is, for example, formed to correspond with contact sections 14a and 14b and prevents, for example, a shift in longitudinal direction relatively to the transverse seal 10.

In order to introduce the pressing force in vertical direction into contact element 22 via the pressure element 25 and to prevent relative movement in vertical direction, the pressure element 25 has, for example, a section 27, which corresponds to contact element 22 where a projection 27a on pressure element 25 engages for example, in a groove 27b on contact element 22.

In the case of a two-piece sealing cheek 12, both the contact element 22 and the pressure element 25 are made from ceramic material. It is, however, also possible to make only one element, for example the pressure element 25 for potential separation of the fuel cell 2 and the gas distributor 5, from a dielectric material.

In the case of a (to be compensated) movement of, for example, the fuel cell 2 and/or the end plate 4 in transverse direction and/or of combined movements with, for example, a transverse direction component, the contact element 22 is pressed by the pressure element 25 against the end plate 4 and the fuel cell 2, insofar as the pressing arrangement 18 follows the movement in an elastic manner. In the case of a movement of the fuel cell 2, or of the end plate 4 in vertical direction away from the sealing arrangement 6, the pressure element 25 presses the contact element 22 via the corresponding sections 27, against the contact section 14c of the projection 13 and so prevents the formation of an open crack 11. In the case of a longitudinal movement, the contact element 22 together with the end plate 4, or the fuel cell 2, can move relatively to the pressure element 25 along a sliding level formed between sliding surfaces 24, 26, so that wear on a sealing material 17 arranged between the contact element 22 and the end plate 4 or the fuel cell 2 can be minimized. To this extent, the two-piece sealing cheek 12 is, for example, suitable for ongoing use.

The invention also provides for forming the sealing cheek 12 in three pieces, that is to say, from a first, a second and a third element. In the case of three pieces, a possible (thermal) relative longitudinal direction movement between the longitudinal and the transverse seals 9 or 10 and the gas distributor 5, may be taken into account. The three-piece sealing cheek 12 has a previously explained contact element 22, which is, in turn, in contact with the end plate 4 and the fuel cell 2, or the fuel cell stack 3. The three-piece sealing cheek 12 also has a previously explained pressure part 25 with a third sliding surface 28 opposite the second sliding surface 26, against which a fourth sliding surface 29 may be introduced for contact and longitudinal movement.

The fourth contact surface 29 is formed on a adaptation element 30, which is pressed against the pressure element 25 via the fourth contact surface 29. The adapter, or the adapter element 30 extends, for example, substantially to the same extent as that of the pressing element 18 or may be somewhat longer and is fixed by the latter against movement in longitudinal direction relatively to the pressing element 18, for example via two projections 31, or flags.

To ensure that the pressure force can be introduced in vertical direction via the adapter element 30 into the pressure element 25 and the contact element 22 and in order to avoid a relative vertical movement, the pressure element 25 and the contact element 22 also have a section corresponding to the adjoining elements 22, 25, 20, where, for example, the projection on the pressure element 25 engages, for example, in a groove on the contact element 22 and where a projection on the adapter element 30 engages, for example, in a groove on the pressure element 25 in a form-fitting manner.

The adapter element 30 is provided by the pressing element 18 with a pressure force in vertical and transverse direction, so that the contact element 22 is pressed via pressure element 25 and adapter element 30, against projection 13, the end plate 4 and the fuel cell 2.

In the case of the three-piece sealing cheek 12, the projection 13 has, in addition to the first and the second contact section 14c, 14d, a third contact section 14e on the adapter element 30, where the adapter element 30 has a section corresponding to the third contact section 14e. The third contact section 14e is formed for sliding contact with the adapter element 30 in longitudinal direction, in particular, for example, for sliding contact with a freedom of movement away from the transverse seal 10. The adapter element 30 can, for example, exert an impact, for example in the direction of transverse seal 10, in the form of a groove limiting a movement in the direction of the third contact section together with a projection of the third contact section 14e.

In the case of the three-piece sealing cheek, for example the contact element 22 and the pressure element 25 as well as the adapter element 30, are made from ceramic material. It is however sufficient if one of the three elements 22, 25 and 30 for the potential separation of the fuel cell 2 and the gas distributor 5, is made from dielectric material.

In the case of a movement in transverse direction or with a transverse component, to be compensated, in the area of possible crack formation, the three-piece sealing cheek 12 follows the movement due to the elasticity of the pressing element 18, with sliding levels located between the contact element 22 and the pressure element 25, as well as between the pressure element 25 and the adapter element 30, in all cases between the sliding surfaces 24, 26 and 28, 29. Like the two-piece sealing cheek 12, the three-piece sealing cheek 12 is also suitable for ongoing use due to a low rate of material wear.

Elements 22, 25, 30 of sealing cheeks 12 are destined to have ground or polished sliding surfaces 16, 24, 26, 28, 29, namely surfaces with a low friction coefficient and in particular, surfaces able to prevent the leakage of liquids or gases.

1. A fuel cell arrangement with an end plate, an adjoining fuel cell and a longitudinal seal, a transverse seal where the transverse seal extends in transverse direction along the end plate and where the longitudinal seal extends along the fuel cell and the end plate in longitudinal direction, up to the transverse seal, wherein for sealing a crack open outwards in the area between the end plate, the fuel cell, the transverse seal and the longitudinal seal are pressed via an elastic pressing element against a projection formed in transverse direction by the longitudinal seal and the transverse seal, and the end plate and the fuel cell, where the sealing cheek forms a sliding surface in the direction of the fuel cell and the end plate and where the sealing cheek has a contact section corresponding to a contact section of the projection.

2. The fuel cell arrangement of claim 1, wherein the contact section of the projection has a contact section formed by the transverse seal to prevent relative movement of the sealing cheek pressed to the contact section in longitudinal direction.

3. The fuel cell arrangement of claim 1, wherein the sealing cheek has a reception surface or a guide for the pressing element.

4. The fuel cell arrangement of claim 1 wherein the sealing cheek has two elements such that a contact element of the sealing cheek has a contact surface on the fuel cell and on the end plate, and a first sliding surface for contact on a pressure element, where the pressure element is pressed against the contact element via the pressing element, where the pressure element acts jointly with the contact element against the vertical relative movement and where the pressure element has a second sliding surface for contact with the first sliding surface, where the contact element is pressed against the projection via the pressure element and where the end plate and the fuel cell are pressed against one another longitudinally and in a sliding manner via the sliding surfaces.

5. The fuel cell arrangement of claim 4, wherein the projection has a first contact section for contact with the contact element and a second contact section for contact with the pressure element, where the contact element and the pressure element each have a section corresponding to a first or a second contact section, where the first contact section is formed for longitudinal sliding contact with contact element and where the second contact section has a contact section formed by the transverse seal for preventing a longitudinal relative movement of the pressure element.

6. The fuel cell arrangement of claim 4, wherein the sealing cheek has a third adapter element such that the adapter element is pressed via pressing element against the pressure element, where the adapter element together with the pressure element acts jointly with the pressure element against vertical relative movement, where the pressure element has a third sliding surface and where the adapter element has a fourth sliding surface, where the adapter element can be longitudinally slid via the third and fourth sliding surfaces relatively to the pressure element, where the contact element is pressed against the projection via the pressure element and the adapter element, the end plate and the fuel cell against one another via the sliding surfaces in a longitudinally sliding manner.

7. The fuel cell arrangement of claim 5, wherein the projection has a third contact section for contact on the adapter element, where the adapter element has a section corresponding with the third contact section and where the third contact section is formed to have sliding contact of the adapter element in longitudinal direction.

8. The fuel cell arrangement of claim 4, wherein the contact element, the pressure element or the pressure element and the adapter element have corresponding sections for the prevention of vertical relative movement.

9. The fuel cell arrangement of claim 1, wherein the contact section of the projection formed by the longitudinal seal is formed for longitudinal sliding contact.

10. The fuel cell arrangement of claim 1, wherein the pressing element is a spring, in particular a spring with an S-shaped cross-section, where the pressing element (18) exerts a force in both vertical and transverse direction on the sealing cheek.

11. The fuel cell arrangement of claim 1, wherein the pressing element is supported on a gas distributor of the fuel cell arrangement via a retention arrangement.

12. The fuel cell arrangement of claim 1, wherein the sealing cheek has an element made from dielectric material.

13. The fuel cell arrangement of claim 1, wherein the sealing cheek has an element made from a ceramic material.
